(19) United States
(12) Patent Application Publication
(10) Pub. No.: US 2017/0221086 A1
(43) Pub. Date: Aug. 3, 2017

(54) FRAMEWORK FOR GENERATING COUPONS

(71) Applicant: SAP SE, Walldorf (DE)

(72) Inventors: Wenjun ZHOU, Shanghai (CN); Wen-Syan LI, Shanghai (CN)

(21) Appl. No.: 15/009,795

(22) Filed: Jan. 28, 2016

(51) Int. Cl. G06Q 30/02

(52) U.S. Cl. CPC G06Q 30/0211; G06Q 30/0247

(57) ABSTRACT

A framework to generate coupons is described herein. In accordance with one aspect of the framework, historical data is retrieved from the database and used to predict sales orders within a time period of a marketing campaign. One or more of the predicted sales orders are selected to maximize return-on-investment within one or more constraints. Coupons are generated based on the selected one or more predicted sales orders for distribution to customers. Results of the generated coupons may then he transmitted to one or more client devices.

### TECHNICAL FIELD

The present disclosure relates generally to computer systems, and more specifically, to a framework for generating coupons.

### BACKGROUND

Electronic commerce (or E-commerce) generally refers to trading in products or services using computer networks, such as the Internet. Companies based on E-commerce may offer, for example, online shopping websites, online marketplaces, electronic data interchange, etc. Such companies may be distinguished from those companies that provide on-demand services via, for example, mobile applications (or Apps). Currently, there are many kinds of on-demand services on the market, such as on-demand transportation services, delivery services, home services, health services, and so forth. In order to attract more customers and maintain good relationships with their customers, on-demand service companies typically implement marketing campaigns, such as offering electronic coupons to their customers.

Marketing campaigns are closely linked to consumer behaviors. Consumer behavior towards on-demand services may be very different from consumer behavior towards E-commerce. Accordingly, the marketing strategies for offering electronic coupons for on-demand services and E-commerce may also differ.

For on-demand services, consumer behavior is repetitive. Customers typically consume the same service many times in the same manner. For example, in the context of on-demand transportation services, customers may request for car services repeatedly day and night. On the other hand, for E-commerce, consumer behavior is not repetitive in most cases. For example, customers will generally not buy the same book again and again from an online bookstore. Accordingly, on-demand service companies need to consider when and how many times to offer electronic coupons, while the problem will be much easier for E-commerce companies to solve.

The request for on-demand services is typically time-sensitive. If the electronic coupons are not offered to the customer on time, the customer will most likely use the on-demand services from competitors that offer coupons earlier. In contrast, E-commerce usually does not require that much time sensitivity, and the valid period of coupon is typically long-term. Customers may browse online shopping websites without a clear target.

For E-commerce, the price of the product is usually static. With a static price, it is easier to define the coupon value. For example, with a book price of $50, the coupon value can be defined as $5 if the company wants to offer a 10% discount. The price for on-demand services, however, is dynamic. For example, the price for on- demand transportation services is determined by many factors, such as driving distance, car type, time, etc. Another example is on-demand delivery services. Customers pay various prices for each on-demand service. This requires the on-demand service companies to consider how to set coupon value. Static coupon values may seem unreasonable. For example, paying $50 for a trip with a coupon offering a discount of $5 is vastly different from paying $10 for a trip with a coupon offering a discount of $5. In short, it is much more complicated for on-demand service companies to optimize electronic coupon offers.

### SUMMARY

A framework for generating coupons is described herein. In accordance with one aspect of the framework, historical data is retrieved from the database and used to predict sales orders within a time period of a marketing campaign. One or more of the predicted sales orders are selected to maximize return-on-investment within one or more constraints. Coupons are generated based on the selected one or more predicted sales orders for distribution to customers. Results of the generated coupons may then be transmitted to one or more client devices.

With these and other advantages and features that will become hereinafter apparent, further information may be obtained by reference to the following detailed description and appended claim s, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2 shows an exemplary method for generating coupons;

FIG. 3 shows an exemplary graph that summarizes historical sales orders associated with a customer;

FIG. 4 shows an exemplary chart that summarizes historical coupon distribution record data for a certain customer during a marketing campaign;

FIG. 5 shows an exemplary user interface screen arranged to enable a user to create or edit a marketing campaign;

FIG. 6 shows an exemplary user interface screen arranged to display coupon distribution results via user interface; and

FIG. 7 shows an exemplary pseudo code.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for generating coupons is described herein. One aspect of the present framework generates customized time-sensitive electronic coupons for discounts on purchases of on-demand products or services. The present framework automatically predicts consumer behaviors during the time period of the marketing campaign based at least in part on historical data. Such prediction results advantageously enables the offering of coupons at the time when customers are most likely to request the on-demand products or services. The present framework may automatically optimize various coupon parameters (e.g., redemption value, distribution date, expiration date, target customer type) so as to maximize return-on-investment while observing certain constraints (e.g., budget, time). The optimization may be performed at the individual customer level, instead of customer segmentation group level. The electronic coupons may also be offered repeatedly during the marketing campaign. These and other exemplary features and advantages will be described in more details herein.

It should be appreciated that he framework described herein may be implemented as a method, a computer-controlled apparatus, a computer process, a computing system, or as an article of manufacture such as a computer-usable medium. These and various other features and advantages will be apparent from the following description.

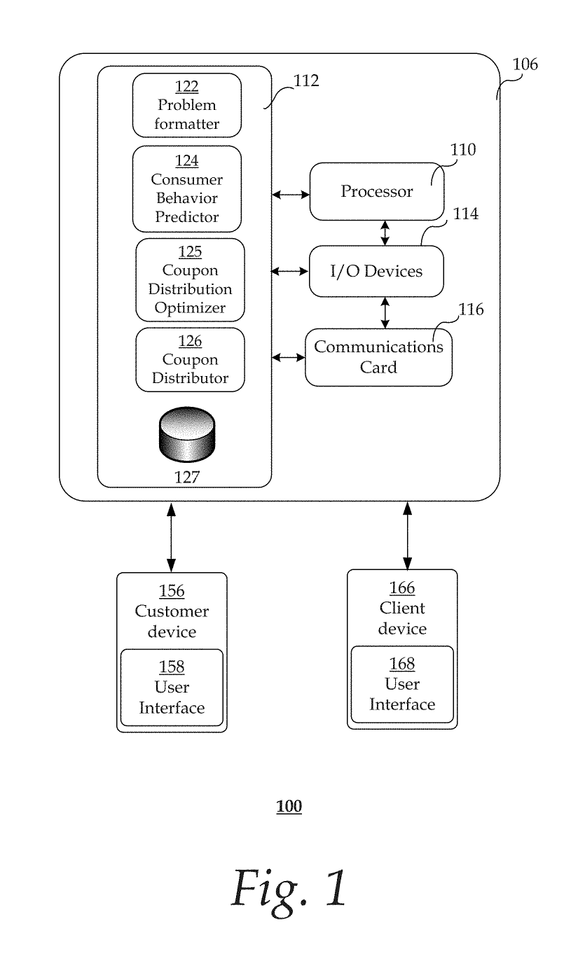

FIG. 1 is a block diagramating an exemplary architecture 100 in accordance with one aspect of the present framework. Generally, exemplary architecture 100 may include a server 106, one or more customer devices 156 and one or more client devices 166.

Server 106 is capable of responding to and executing instructions in a defined manner. Server 106 may include a processor 110, input/output (I/O) devices 114 (e.g., touch screen, keypad, touch pad, display screen, speaker, etc.), a memory module 112 and a communications card or device 116 (e.g., modem and/or network adapter) for exchanging data with a network (e.g., local area network or LAN, wide area network (WAN), Internet, etc.). It should be appreciated that the different components and sub-components of the server 106 may be located or executed on different machines or systems. For example, a component may be executed on many computer systems connected via the network at the same time (i.e., cloud computing).

Memory module 112 may be any form of non-transitory computer- readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks or cards, magneto-optical disks, Compact Disc Read-Only Memory (CD-ROM), any other volatile or non-volatile memory, or a combination thereof. Memory module 112 serves to store machine-executable instructions, data, and various software components for implementing the techniques described herein, all of which may be processed by processor 110. As such, server 106 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, Java, JavaScript, Advanced Business Application Programming (ABAP™) from SAP® AG, Structured Query Language (SQL), etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In some implementations, memory module 112 includes a problem formatter 122, a consumer behavior predictor 124, a coupon distribution optimizer 125, a coupon distributor 126 and a database 127. Database 127 may store, for example, historical sales orders from customers, coupon distribution history, coupon redemption history and marketing campaign data for use in predicting consumer behavior and generating optimal parameters for coupons.

Problem formatter 122 may serve to read data from the database 127 and format the data to be readable by the other components. Consumer behavior predictor 124 may serve to predict consumer behavior during the marketing campaign period. Consumer behavior predictor 124 may include a sales timestamp predictor, a consumption value predictor and a coupon redemption value predictor. Coupon distribution optimizer 125 may serve to calculate coupon parameters based on the predicted consumer behavior to optimize coupon distribution. Coupon distribution optimizer 125 may include, for example, a return-on-investment (ROI) ratio calculator, a customer selector and a budget updater.

Server 106 may operate in a networked environment using logical connections to one or more customer devices 156 and one or more client devices 166. Customer device 156 and client device 166 are capable of responding to and executing instructions in a defined manner. Customer device 156 and client device 166 may include components shown) similar to server 106, such as a processor, I/O devices, non-transitory memory module and communications card. Customer device 156 may further include user interface 158 (e.g., graphical user interface) arranged to display electronic coupons that can be used by customers for purchase of on-demand services. Client device 166 may further include a user interface 168 arranged to enable the user to initiate the design of a marketing campaign and/or communicate information with server 106.

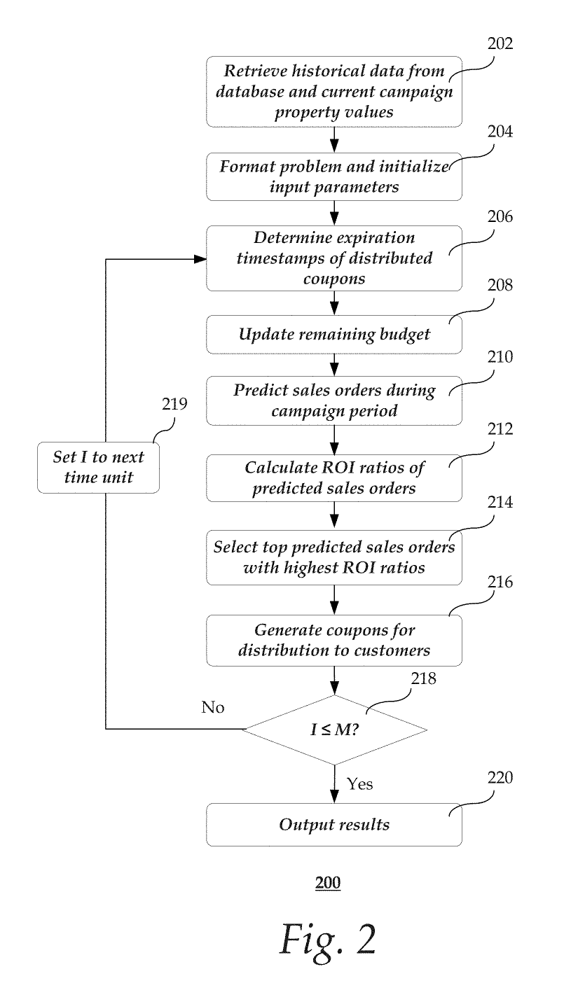

FIG. 2 shows an exemplary method 200 for generating coupons. The method 200 may be performed automatically or semi-automatically by the system 100, as previously described with reference to FIG. 1. It should be noted that in the following discussion, reference will be made, using like numerals, to the features described in FIG. 1.

At 202, problem formatter 122 retrieves historical data from database 127 and property values of a current campaign from client device 166. The historical data may include, but are not limited to, historical sales orders from customers, historical coupon distribution records, historical coupon redemption records and historical marketing campaign data records.

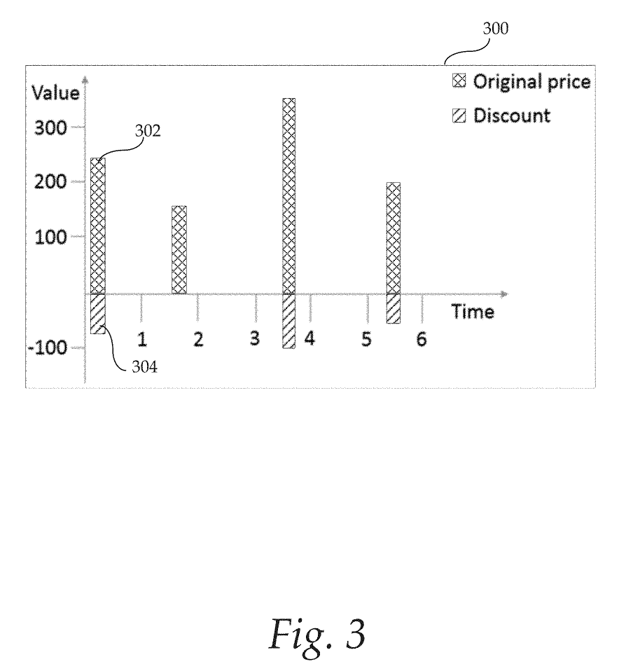

Each historical sales order may be represented by a database table (or other data structure) that stores, for example, a unique identifier (ID) of the sales order, original price of the product or service, redeemed discount value (zero if coupon was not redeemed), net price after applying discount value, timestamp of sales order, coupon identifier (null if coupon was not redeemed), identifier of customer who bought the product or service, and so forth. FIG. 3 shows an exemplary graph 300 that summarizes historical sales orders associated with a customer. More particularly, the graph 300 depicts the original price 302 and coupon discount 304 redeemed by the customer at different time stamps.

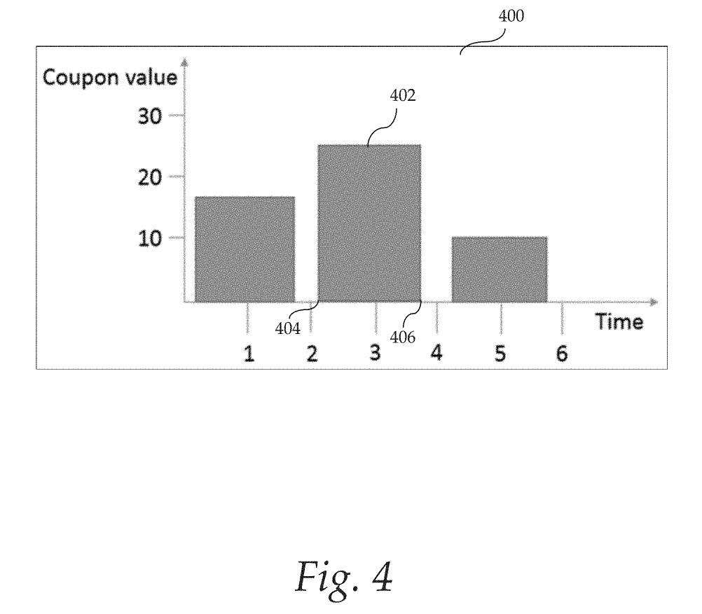

Each historical coupon distribution record may be represented by a database table (or other data structure) that stores, for example, a coupon identifier, value of the coupon, distribution timestamp, expiration timestamp, identifier of customer to whom the coupon was offered, identifier of marketing campaign, and so forth. FIG. 4 shows an exemplary chart 400 that summarizes historical coupon distribution record data for a certain customer during a marketing campaign. Each bar 402 in the chart 400 represents a coupon. The height of the bar 402 represents the coupon value. The width of the bar 404 represents the time period during which the coupon is valid, with the starting point 404 representing the distribution timestamp and the ending point 406 representing the expiration timestamp.

Each coupon redemption historical record may be represented by a database table (or other data structure) that stores, for example, a coupon identifier, redemption timestamp and identifier of customer who redeemed the coupon. Each marketing campaign data record may be represented by a database table (or other data structure) that stores, for example, campaign identifier, campaign name, campaign budget, start and end timestamps of the campaign,

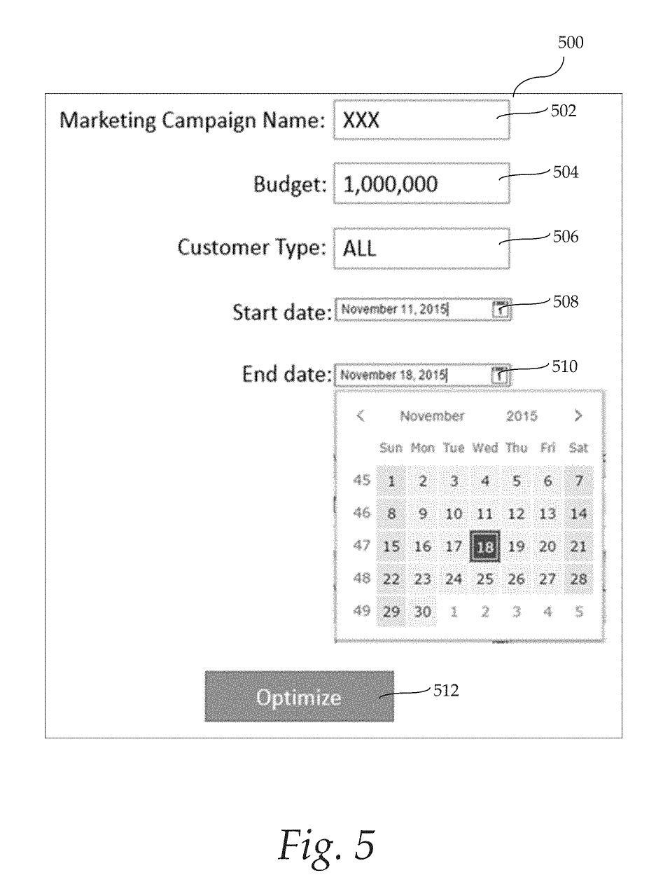

The generation or modification of a current marketing campaign may be initiated by a user via user interface 168 at the client device 166. FIG. 5 shows an exemplary user interface screen 500 arranged to enable a user to create or edit a marketing campaign. The user interface screen 500 may be generated by, for example, a mobile application or other type of software application on the client device 166. The user interface screen 500 may display various user-editable fields 502-510 for customizing campaign property values. The fields may include, but are not limited to, campaign name 502, campaign budget 504, target customer type 506 (e.g., new user, very important person, all, etc.), start date (or timestamp) 508 and end date (or timestamp) 510 of the marketing campaign. The budget 504 is the estimated expenditure intended for marketing purposes (e.g., coupon redemption values). The total redemption value of distributed coupons should not exceed the budget 504. The target customer type 506 enables the filtering of customer types to limit the distribution of coupons to the selected customer types. The user interface screen 500 may further include an “Optimize” button 512 (or other user interface element) that the user can activate to invoke the optimization process (e.g., steps 204-220) to optimize the coupons offered during the marketing campaign. The client device 166 may also transmit the campaign property values to the problem formatter 122 in response to the activation of the “Optimize” button.

Returning to FIG. 2, at 204, problem formatter 122 determines the objective function and initializes input parameters of the objective function based on the historical data and current campaign property values.

In some implementations, the objective function maximizes return-on- investment while fulfilling one or more predefined constraints. Assume that there are N customers Uᵢ, wherein index i=N, and M historical sales orders Sᵢⱼ, wherein j=1, 2, . . . , M associated with each customer. Each customer Uᵢ may be associated with the historical sales order Sᵢⱼ with original price Oᵢⱼ, discount Dᵢⱼ with the coupon Cᵢⱼ, actual amount Aᵢⱼ and the timestamp of the sales order Tᵢⱼ₁, wherein i represents the index of the customer and j represents the index of the historical sales order. Assume that there are L offered electronic coupons Cₖ, k=1, 2, . . . L with the value Vₖ, distribution timestamp Dₖ, expiration timestamp Eₖ and targeted customer Tₖ.

Based on the historical data of sales orders and coupon distribution, the framework may seek to optimize parameters (e.g., value, distribution date, expiration date) of time-sensitive electronic coupons to offer to various customers in order to maximize the return-on-investment, given the budget constraint B and the time period constraint with start time S and end time E of the marketing campaign.

Suppose there are H customized time-sensitive coupons Cnₕ, h=1, 2, . . . , H to be offered while maximizing the return-on-investment within the budget constraint B and the time period constraint. The objective function may then be expressed as follows:

Maximize(Σₕ₌₁^{H}Rₕ−Vnₕ) (1)

wherein Rₕ represents the predicted returns of coupon h and Vnₕ represents the redemption value of coupon h (e.g., if the customer buys the product or uses the services with coupon $5 and the original price is $50, the return is $45).

The objective function may be maximized within the following constraints:

Σₕ₌₁^{H}Vnₕ≦B (2)

which means the total redemption value of offered coupons cannot exceed the budget limitation B;

Dnₕ≧S, h=1, 2, . . . H (3)

which means all distribution timestamps Dnₕ of coupons must be greater than or equal to the start timestamp of the campaign;

Enₕ≦E, h=1,2, . . . H (4)

which means all expiration timestamps Enₕ of coupons must be less than or equal to the end timestamp E of the campaign; and

Trₕ≦E, h=1, 2, . . . H (5)

which means all predicted redemption timestamps Trₕ of coupons must be less than or equal to the end timestamp E of the campaign.

In some implementations, problem formatter 122 initializes the following input parameters of the objective function (1) and constraints (2)-(5) based on the historical data and current campaign property values: (1) total budget of the campaign (B); (2) start time of campaign (S); end time of campaign (H); (3) time unit in the period of campaign (U); (4) number of time units

$$M = \frac{E - S}{U} ;$$

(5) index of time unit (I) set to 0; (6) remaining budget Br=B; (7) predicted sales order Spᵢₚ from customer Uᵢ during the period of campaign with the predicted timestamp Tpᵢₚ, consumption value Opᵢₚ and redeemed coupon value Dpᵢₚ; (8) new customized time-sensitive electronic coupon Cdᵢ distributed to customer Uᵢ; and (9) status flag Fᵢ of Cdᵢ set to 1 if Cdᵢ is redeemed, otherwise set to 0.

At 206, coupon distribution optimizer 125 determines the expiration timestamps (or dates) of distributed coupons Cdᵢ. These coupons Cdᵢ may have been distributed to customers Uᵢ during, for example, the previous time unit. If any of the coupons Cdᵢ have expired (i.e., expiration timestamps are earlier than current timestamp), the value of the respective expired coupon Cdᵢ is set to null.

At 208, coupon distribution optimizer 125 updates the remaining budget Br for the marketing campaign. The budget may be updated by subtracting the redemption values of distributed coupons from the currently available budget Br. More particularly, the budget may be updated by determining the following:

Br=Br−Σᵢ₌₁^{N} CdᵢFᵢ (6)

wherein Br denotes the remaining budget, Cdᵢ denotes the distributed coupon redemption value, i is the index of the customer, N is the total number of customers, and Fᵢ denotes the status flag of Cdᵢ. Fᵢ is set to 1 if coupon Cdᵢ is redeemed, otherwise set to 0. After the budget is updated, coupon distribution optimizer 125 invokes consumer behavior predictor 124 to predict consumer behavior parameters.

At 210, consumer behavior predictor 124 predicts sales orders that may be made during the period of the marketing campaign. The predicted sales orders reflect consumer behavior during the campaign period, and may be predicted based on the retrieved historical data. Each predicted sales order may be denoted by Spᵢₚ, wherein the customer index i=1, 2, . . . , N and the campaign time unit index p=1, 2, . . . , M Each predicted sales order Spᵢₚ may include predicted sales timestamp, predicted consumption value and predicted coupon redemption value. The consumption value indicates the original price of product or service without the coupon discount. In some implementations, the sales timestamps and consumption values are predicted based on historical sales orders. The coupon redemption values may be predicted based on historical coupon redemption data.

In some implementations, triple exponential smoothing is used to predict the sales orders (e.g., predicted sales timestamp, consumption value, coupon redemption value) based on the historical data. Triple exponential smoothing is a technique that can be used to smooth the historical time series data while taking into account seasonal changes in the time series data. Seasonality generally refers to the tendency of the time-series data to exhibit behavior that repeats itself every L periods. Consumer behavior reflected by the historical data may be assumed to contain a seasonal component. For example, for on-demand car services, consumers usually request car services when they go to the office in the morning and return home in the evening.

At 212, coupon distribution optimizer 125 calculates the return-on-investment (ROI) ratio for each predicted sales order. The ROI ratio is the ratio of the predicted consumption value to predicted coupon redemption value. A higher ratio indicates a higher return-on-investment (or profit). The predicted sales orders may then be sorted in a descending order list according to the ROI ratios.

At 214, coupon distribution optimizer 125 selects top predicted sales orders that optimizes an objective function within one or more constraints. In some implementations, the predicted sales orders that maximize return-on-investment within one or more constraints are selected. Coupon distribution optimizer 125 may select the predicted sales orders with the highest ROI ratios from the sorted list. For example, coupon distribution optimizer 125 may select a predetermined number of predicted sales orders with highest ROI ratios, wherein the total sum of redemption values of the selected orders is less than or equal to the remaining budget Br of the campaign. More particularly, coupon distribution optimizer 125 may select H Dpᵢₚ from the beginning of the sorted list with the constraint ΣDpᵢₚ≦Br, wherein Dpᵢₚ is the coupon redemption value associated with the predicted sales order Spᵢₚfrom customer Uᵢ in the campaign period.

At 216, coupon distributor 126 generates coupons to be distributed to customers associated with the selected sales orders. In some implementations, coupon distributor 126 generates electronic coupons Cdᵢ customized with optimal coupon parameters (e.g., redemption value, distribution timestamp, expiration timestamp) based on the selected sales orders. More particularly, for each coupon redemption value Dpᵢₚ associated with the selected sales order Spᵢₚ to customer Uᵢ, if flag Fᵢ is set to 1 and Cdᵢ is not null, the coupon Cdᵢ may be generated with redemption value Dpᵢₚ, distribution timestamp=current time unit index I, expiration timestamp set=timestamp of the predicted consumption timestamp Tpᵢₚ, and status flag Fᵢ=0. The distribution timestamp should be greater than or equal to a start timestamp of the marketing campaign, while the expiration timestamp should be less than or equal to an end timestamp of the marketing campaign. The electronic coupon may further include a unique identifier (e.g., barcode, text string) that the customers may provide while purchasing the associated on-demand products or services to obtain a discount.

At 218, coupon distributor 126 determines whether all the time units of the campaign are processed. If the current time unit index I has reached the maximum number M, all the time units of the campaign have already been processed and the method 200 proceeds to 220. If not, the time unit index I is incremented at 219, and steps 206 to 216 are repeated to optimize the coupons for the remaining time units.

At 220, coupon distributor 126 outputs the coupon distribution results. Coupon distribution results may be transmitted to one or more client devices 166. The user interface 168 on the client device 166 may be arranged to display the coupon distribution results. The coupon distribution results may include multiple records associated with coupons that were distributed. Each coupon record may include a database table (or other data structure) that stores, for example, a coupon identifier, a coupon redemption value, distribution and expiration timestamps dates) of the coupon, identifier of customer to whom the coupon was distributed, customer type (e.g., new user, very important person, etc.), identifier of the campaign, and so forth. In some implementations, the generated coupons are transmitted to one or more mobile devices 156 associated with the customers. The user interface 158 on the mobile device 156 may be arranged to display the electronic coupons.

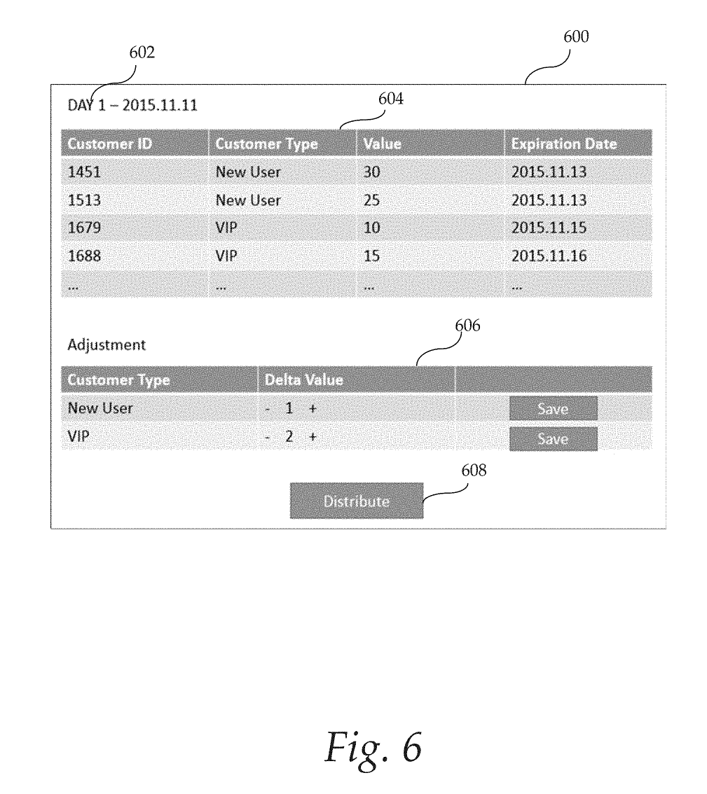

FIG. 6 shows an exemplary user interface screen 600 arranged to display coupon distribution results via user interface 168. As shown, the coupon distribution results include a distribution date 602 and a table 604 indicating the coupon records that were generated by the present framework. Each row of the table 604 corresponds to a coupon record and indicates the customer identifier, the customer type, coupon redemption value and expiration date of the coupon. The redemption value of the coupon may be adjusted for different types of customers. Table 606 enables a user to configure the adjustment delta value for each type of customer. For example, coupon redemption value for a new user may be adjusted upwards by a delta value of 1, and the coupon redemption value for a very important person (VIP) may be adjusted upwards by a delta value of 2, A “Distribute” button 608 (or any other user interface element) may further be displayed to enable a user to initiate the distribution of the coupons to the respective customers.

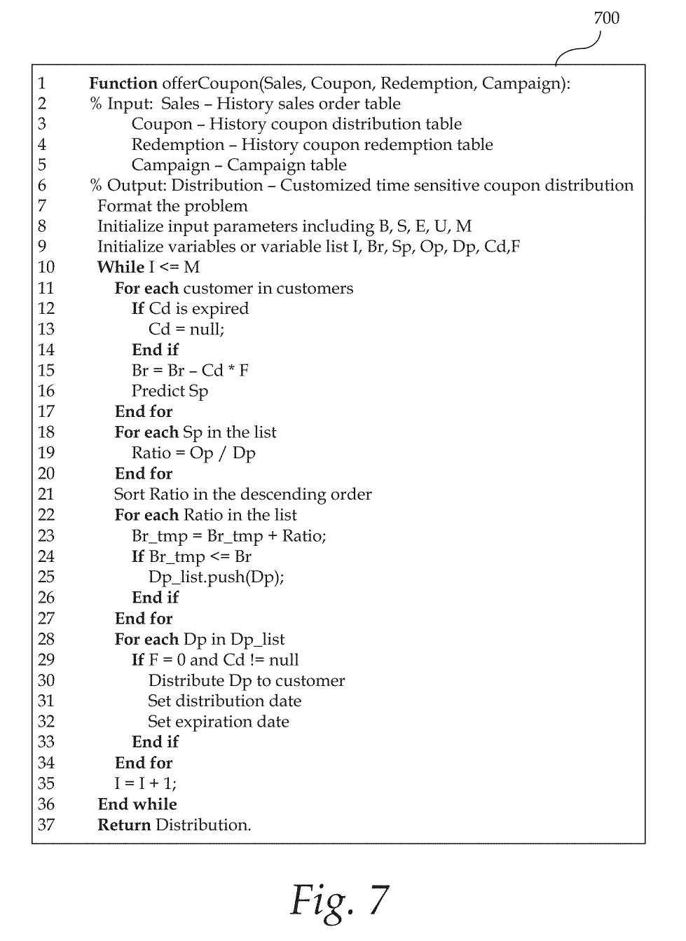

FIG. 7 shows an exemplary pseudo code 700 that may be used to implement the present framework.

An exemplary application of the present framework will now be described. Assume that the present framework is applied in a marketing campaign for an on-demand transportation services company. The marketing campaign may be created by a user via, for example, user interface 168 at client device 166. The user may input, for example, the campaign budget (e.g., 10 USD), start date 2015.11.11) and end date (e.g., 2015.11.18). In addition, the customer type may also be filtered to limit the distribution of coupons to only new users, VIPs or for all users.

The objective function is to maximize the return-on-investment (ROI), which means that we want to earn as much as possible given the limited campaign budget for coupon redemption values. For instance, based on the consumption history of customer A, the framework may determine that A uses our transportation on-demand services twice each workday at the time going to work (e.g., around 8 a.m.) and going back home (e.g., around 6 p.m.). Since the distance between the work place and home is relatively stable and unchanged, it can be determined that A usually spends 20 USD and redeems a coupon to obtain a discount of 1 USD. Therefore, A pays 19 USD for each workday. On the other hand, the framework may determine from the historical consumption data that customer B is very coupon-sensitive, which means that customer B only uses the on-demand transportation services during weekends when the coupon redemption value is 10 USD and ROI is very low.

The framework may first predict the potential consumption of each customer during the period of the marketing campaign and distribute coupons day-by-day instead of distributing all coupons at once. For customer A, the framework may predict that customer A will still use the on-demand transportation service each workday. Accordingly, for each weekday, the framework may distribute two coupons with 1 USD redemption value to customer A, and if customer A redeems those two coupons, two more coupons may be distributed to customer A again. For one week, the framework may only offer customer A 10 coupons, which means the cost is 10*1=10 USD, but returns are 20*10=200 USD. The ROI is very high. For customer B since customer B is predicted to only use the on-demand service during weekends, the ROI is lower than customer A. Since the campaign budget of 10 USD is already used up by customer A's coupons, customer B will not be offered coupons.

Consider the case if the coupon with 10 USD redemption value is offered to customer B. From the historical data, the framework can predict that customer B only uses the on-demand transportation service when he has a coupon with 10 USD and he will not pay more than 5 USD (e.g., more willing to take a bus in this case). The transportation service only costs 15 USD, so customer B only pays 5 USD. In this case, the returns are only 5 USD compared to 190 USD gained from customer A.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A system for generating coupons, comprising:
one or more client devices;
one or more customer devices;
a non-transitory memory device for storing a database and computer-readable program code; and
a processor in communication with the memory device, the one or more client devices and the one or more customer devices, the processor being operative with the computer-readable program code to perform operations including
(i) retrieving historical data from the database,
(ii) predicting, based on the historical data, sales orders within a time period of a marketing campaign,
(iii) calculating return-on-investment ratios of the predicted sales orders,
(iv) selecting one or more of the predicted sales orders based on the return-on-investment ratios and a constraint on a budget of the marketing campaign,
(v) generating, based on the selected one or more of the predicted sales orders, coupons for distribution to customers,
(vi) transmitting results of the generated coupons to the one or more client devices for display, and
(vii) transmitting, in response to a user input at the one or more client devices, the generated coupons to the one or more customer devices for display.

2. The system of claim 1 wherein the historical data comprises historical sales orders from customers, historical coupon distribution records, historical coupon redemption records, historical marketing campaign data records, or a combination thereof.

3. The system of claim 1 wherein the processor is operative with the computer-readable program code to predict the sales orders by predicting sales timestamps and consumption values based on historical sales orders.

4. The system of claim 1 wherein the processor is operative with the computer-readable program code to predict the sales orders by predicting coupon redemption values based on historical coupon redemption data.

5. A method of generating coupons, comprising:
retrieving, by a processor, historical data from a database;
(ii) predicting, by the processor based on the historical data, sales orders within a time period of a marketing campaign;
(iii) selecting, by the processor, one or more of the predicted sales orders that maximize return-on-investment within one or more constraints;
(iv) generating, by the processor based on the selected one or more of the predicted sales orders, coupons for distribution to customers; and
(v) transmitting, by the processor, results of the generated coupons to one or more client devices.

6. The method of claim 5 further comprising displaying, at a client device, a user interface screen arranged to enable a user to create or edit the marketing campaign.

7. The method of claim 6 wherein the user interface screen is further arranged to enable the user to limit the distribution of the coupons to a type of customer.

8. The method of claim 5 further comprising displaying, at a user device, at least one of the generated coupons.

9. The method of claim 5 further comprises updating a budget of the marketing campaign based on redemption values of distributed coupons.

10. The method of claim 9 wherein selecting the one or more of the predicted sales orders comprises selecting the one or more of the predicted sales orders that maximizes return-on-investment within a budget constraint of the marketing campaign.

11. The method of claim 5 wherein predicting the sales orders comprises predicting sales timestamps and consumption values based on historical sales orders.

12. The method of claim 5 wherein predicting the sales orders comprises predicting coupon redemption values based on historical coupon redemption data.

13. The method of claim 5 wherein predicting the sales orders comprises performing triple exponential smoothing on the historical data.

14. The method of claim 5 wherein selecting the one or more of the predicted sales orders comprises:
calculating return-on-investment ratios for the predicted sales orders; and
selecting the one or more predicted sales orders based on the return-on-investment ratios, wherein a total sum of redemption values of the predicted sales orders is less than or equal to a budget.

15. The method of claim 14 wherein the return-on-investment ratios comprise a ratio of a predicted consumption value to a predicted coupon redemption value.

16. The method of claim 5 wherein generating the coupons for distribution to the customers comprises generating the coupons with distribution timestamps greater than or equal to a start timestamp of the marketing campaign.

17. The method of claim 5 wherein generating the coupons for distribution to the customers comprises generating the coupons with expiration timestamps less than or equal to an end timestamp of the marketing campaign.

18. The method of claim 5 wherein generating the coupons for distribution to customers comprises generating a redemption value based on a predicted redemption value of the predicted sales orders.

19. The method of claim 5 wherein generating the coupons for distribution to customers comprises generating a distribution timestamp and an expiration time stamp.

20. A non-transitory computer-readable medium having stored thereon program code, the program code executable by a computer to perform operations comprising:
(i) retrieving historical data from a database;
(ii) predicting, based on the historical data, sales in a time period of a marketing campaign;
(iii) selecting one or more of the predicted sales orders that maximize return- on-investment within one or more constraints;
(iv) generating, based on the selected one or more of the predicted sales orders, coupons for distribution to customers; and
(v) transmitting results of the generated coupons to one or more client devices.
